(19) United States
(12) Patent Application Publication
(10) Pub. No.: US 2005/0253936 A1
(43) Pub. Date: Nov. 17, 2005

(54) Image processing device and image processing method

(75) Inventors: Toshiya Kogishi, Kyoto (JP); Jun Kajiwara, Kyoto (JP); Kenji Arakawa, Osaka (JP); Toshinobu Hatano, Kyoto (JP); Toshiyuki Nakashima, Osaka (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/119,938

(22) Filed: May 3, 2005

(30) Foreign Application Priority Data
May 13, 2004 (JP) P2004-143479
Apr. 25, 2005 (JP) P2005-126606

(51) Int. Cl. H04N 9/73

(52) U.S. Cl. 348/223.1; 358/516; 348/243

(57) ABSTRACT

An image processing device according to the present invention comprises an image signal operation unit, a correction data operation unit and a correcting unit. The image signal operation unit adjusts a white balance of an image signal by controlling a gain of the image signal for each color constituting the image signal. The correction data operation unit creates correction data for correcting an output of the image signal operation unit. The correcting unit further corrects the output of the image signal operation unit based on the correction data created by the correction data operation unit. According to the present invention, the white balance can be appropriately adjusted without losing subtle shades and shadows of a photographic object even in the case of an image signal including a noise level of a dark current.

### FIELD OF THE INVENTION

The present invention relates to an image processing device and an image processing method, more particularly to a white balance adjustment.

### BACKGROUND OF THE INVENTION

In the case of obtaining an image of a photographic object using a solid image sensor element such as a CCD image sensor element and a CMOS image sensor element, white color included in the photographic object is color-displayed in a state of being shifted to the red-color side on an entire screen when a light source whose color temperature is low, such as a incandescent lamp, is used, while the white color included in the photographic object is color-displayed in a state of being shifted to the blue-color side on the entire screen when a light source whose color temperature is high, such as a solar light, is used.

In order to correct the abnormality generated in the color reproduction, an image processing device generally executes a white balance adjustment for eliminating any dependency of the light source on the color temperature.

FIG. 7 is an example of a constitution of a conventional image processing device capable of adjusting the white balance. Referring to reference numerals in FIG. 7, 101 denotes an image input unit, 111 denotes a multiplier, 120 denotes a clipping circuit, 106 denotes an image output unit, 112 denotes gain data of respective colors, and 113 denotes a selector.

It is assumed, in the shown example, that an image signal is inputted from a single-plate solid image sensor element in which color filters of R (red), B (blue), Gr (green on the same line as red) and Gb (green on the same line as blue) are arrayed in a mosaic shape, that is the so-called Bayer array, as shown in FIG. 2. In the Bayer-arrayed single-plate solid image sensor element, an R signal, a Gr signal, the R signal, the Gr signal, . . . are alternately inputted in R line (pixel array in which R is disposed), and a Gb signal, a B signal, the Gb signal, the B signal, . . . are alternately inputted in B line (pixel array in which B is disposed).

The multiplier 111 multiplies an image signal inputted from the image input unit 101 by the gain data 112 selected in the selector 113 depending on a color of the inputted image signal. More specifically, the R signal is multiplied by R gain, and in the same manner, the Gr signal by Gr gain, the Gb signal by Gb gain, and the B signal by B gain. The gain data of the respective colors are previously calculated in accordance with the color temperature of the light source and memorized. When the image signal is multiplied by the gains of the respective colors, a level of the image signal is corrected so that the white-color object can be displayed in the achromatic white color.

The gain-multiplied image signal level may overflow depending on a gain setting or the level of the inputted image signal. In order to deal with that, upper and lower limits of the corrected image signal level are subjected to restriction by the clipping circuit 120. The image signal thus gain-corrected and thereafter clipped is outputted from the image output unit 106 as a white-balance adjusted image signal.

FIG. 8 are schematic views of an ideal signal level correction according to the foregoing white-balance adjustment. First, itis assumed that input signal levels of the photographic object in the white color are, R signal:Gr signal:Gb signal:B signal=3:6:6:2, based on the color temperature of the light source as shown in FIG. 8A, in contrast to which R gain:2, Gr gain=Gb gain=1,B gain=3 is set and the white-balance adjustment is thereby executed. Provided that the corrected R signal, Gr signal, Gb signal and B signal are respectively an R′ signal, a Gr′ signal, a Gb′ signal and a B′ signal, the followings are obtained.
R=3×2=6
Gr′=Gb′=6×1=6
B′=2×3=6

As shown above, the corrected image signals are all at the same level as shown in FIG. 8B, and the white-color object is color-displayed in the achromatic white color. An example of the foregoing white-balance adjustment is disclosed in No. 2004-23205 of the Publication of the Unexamined Japanese Patent Applications.

In the solid image sensor element, a small number of electric signals are present even in the absence of an incident light. Such a noise current is called a dark current, and a noise resulting from the dark current is superposed on the image signal outputted from the solid image sensor element. When the image signal level is high, no major problem is generated because of a S/N ratio thereby increased. However, when the image signal level is low, an influence from the dark current is remarkably increased due to the reduction of the S/N ratio, which adversely affects the white-balance adjustment. Below is given a detailed description referring to FIG. 9.

In FIG. 9, it is assumed that the input signal levels of the photographic object in the white color are, R signal:Gr signal:Gb signal:B signal=3:6:6:2, based on the color temperature of the light source, as described earlier. However, assuming that a noise level of the dark current is superposed on the image signal at the rate of “1” in the foregoing case, the input signal levels including the noise of the dark current are R signal:Gr signal:Gb signal:B signal=4:7:7:3, as shown in FIG. 9A.

In the same manner as in the process of FIG. 8, when R gain=2, Gr gain=Gb gain=1, B gain=3 is set with respect to the image signal on which the dark current is superposed and the white-balance adjustment is thereby implemented, the corrected R′ signal, Gr′ signal, Gb′ signal and B′ signal result in the followings.
R′=4×2=8
(image signal level=6/noise level=2)
   Gr′=Gb′=7×1=7
(image signal level=6/noise level=1)
   B′=3×3=9
(image signal level=6/noise level=3)

As shown above, the corrected image signals are not at the same level, as shown in FIG. 9B. Therefore, it is not possible to display the achromatic white color even after the white-balance adjustment.

In order to solve the foregoing problem, a conventional method in which the dark current level is subjected to subtraction prior to the white-balance adjustment is available. However, in the case of a high subtraction value, a low level of the image signal is also eliminated, as a result of which subtle shades and shadows of the photographic object are unfavorably lost.

In the case of a low subtraction value, on the contrary, it is not possible to completely eliminate the noise resulting from the dark current. Thus, the influence from the dark current cannot be surely eliminated in the method of reducing the dark current level by subtraction.

### SUMMARY OF THE INVENTION

Therefore, a main object of the present invention is to provide an image processing device capable of executing an appropriate white-balance adjusting process even in the case of an image signal including a noise level of a dark current.

In order to solve the foregoing problem, an image processing device for adjusting a white balance of an image signal outputted from a solid image sensor element according to the present invention is constituted as follows.

The image processing device according to the present invention comprises an image signal operation unit for adjusting the white balance of the image signal by controlling a gain of the image signal for each color constituting the image signal, a correction data operation unit for creating correction data for correcting an output of the image signal operation unit, and a correcting unit for correcting the output of the image signal operation unit based on the correction data created by the correction data operation unit.

According to the present invention, the appropriate white-balance adjusting process can be executed without losing the subtle shades and shadows of a photographic object even in the case of the image signal including the noise level of the dark current.

### BRIEF DESCRIPTION OF THE DRAWINGS

These and other objects as well as advantages of the invention will become clear by the following description of preferred embodiments and explicit in the appended claims of the invention. Many other benefits of the invention, which are not cited in this specification, will come to the attention of those skilled in the art upon implementing the present invention.

FIG. 1 is a block diagram illustrating a schematic constitution of an image processing device according to the present invention.

FIG. 2 shows an example of an array of color filters in a single-plate image sensor element.

FIG. 3 is a bock diagram illustrating an example of the image processing device according to the present invention.

FIG. 4 show a process of the image processing device according to the present invention.

FIG. 5 is a block diagram illustrating another example of the image processing device according to the present invention.

FIG. 6 show another process of the image processing device according to the present invention.

FIG. 7 is a block diagram of a conventional image processing device.

FIG. 8 show a process of the conventional image processing device.

FIG. 9 show a state of the conventional image processing device in which a failure is generated.

### DETAILED DESCRIPTION OF THE PREFERRED EMBODIMENTS

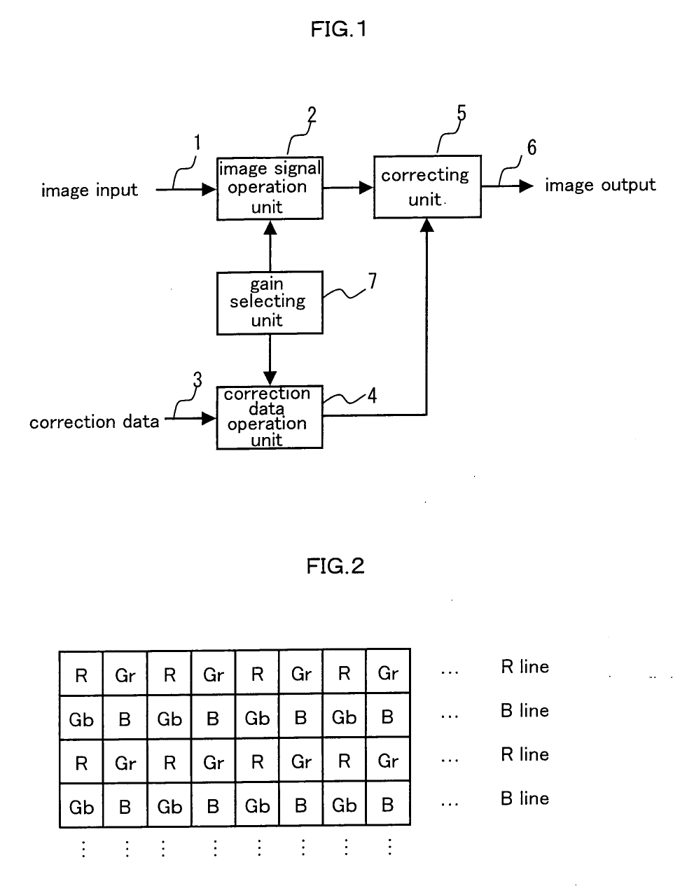

Hereinafter, preferred embodiments of the present invention are described referring to the drawings. First, a block diagram of an image processing device common in two embodiments of the present invention is described referring to FIG. 1. The block diagram shown in FIG. 1 can only be adopted to the two embodiments of the present invention described below, and it is needless to say that the present invention can be realized in any modified constitution within the scope of the purpose of the present invention.

Referring to reference numerals in FIG. 1, 1 denotes an image input unit, 2 denotes an image signal operation unit, 3 denotes a correction data input unit, 4 denotes a correction data operation unit, 5 denotes a correcting unit, and 6 denotes an image output unit.

Below is described an action of the image processing device. An image signal is inputted from the image input unit 1. A gain selecting unit 7 outputs a gain in compliance with a color of the inputted image signal to the image signal operation unit 2. The image signal operation unit 2 executes an operation in compliance with the inputted gain to the image signal.

It is not possible to eliminate an influence resulting from a dark current by executing the foregoing operation alone. Therefore, in the image processing device, the correction data operation unit 4 executes an operation to thereby obtain a correction value based on correction data inputted from the correction data input unit 3 and the gain outputted from the gain selecting unit 7, and outputs the correction value to the correcting unit 5.

The correcting unit 5 corrects the image signal based on the correction value outputted from the correction data operation unit 4 and thereby outputs the image signal which is accurately white-balance adjusted from the image output unit 6.

In embodiments 1 and 2 below, Bayer-arrayed color filters as shown in FIG. 2 are used as color filters arrayed in a front part of a solid image sensor element. In the Bayer array, an R (red) signal, a Gr (green) signal, the R (red) signal, the Gr (green) signal, . . . are alternately inputted in R (red) line (pixel array in which R (red) is disposed), and a Gb (green) signal, a B (blue) signal, the Gb (green) signal, the B (blue) signal, . . . are alternately inputted in B (blue) line (pixel array in which B (blue) is disposed).

### EMBODIMENT 1

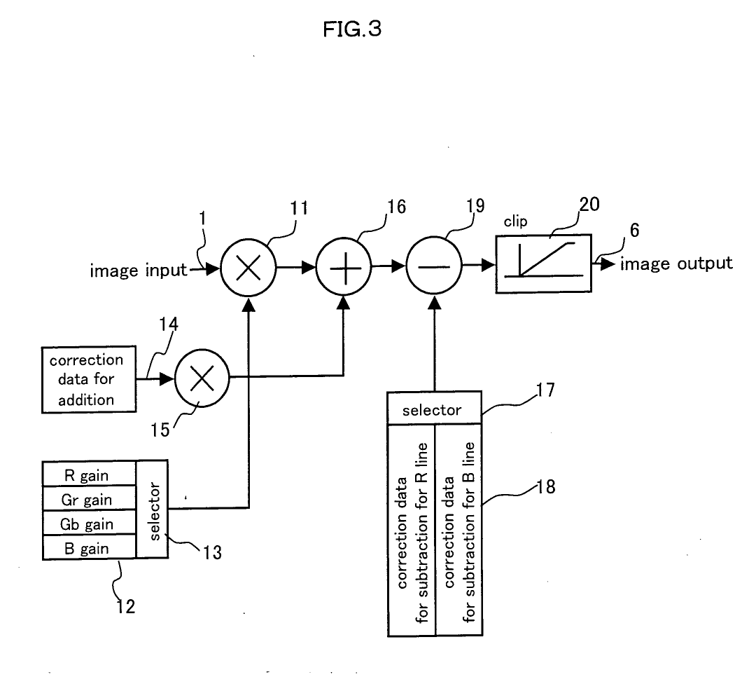

An embodiment 1 of the present invention is described in detail. FIG. 3 shows a specific illustration of an image processing device according to the embodiment 1. The correction data of FIG. 1 corresponds to correction data for addition shown in FIG. 3. The addition correction data is preset and recorded on a correction data memorizing unit for addition 14. The image signal operation unit 2 comprises a multiplier 11. The correction data operation unit 4 comprises a multiplier 15. The gain selecting unit 7 comprises a gain data memorizing section 12 and a selector 13. The correction unit 5 comprises an adder 16, a subtracter 19, a correction data memorizing section for subtraction 18, a selector 17 and a clipping circuit 20.

Below is described an action of the image processing device according to the present embodiment. First, an image signal of a single-plate solid image sensor element according to the Bayer array is inputted from the image input unit 1. In R line of the image signal, an R signal, a Gr signal, the R signal, the Gr signal, . . . are alternately inputted, while a Gb signal, a B signal, the Gb signal, the B signal, . . . are alternately inputted in B line of the image signal. The dark current is superposed on the image signal.

The multiplier 11 multiplies the inputted image signal by a gain. More specifically, the R signal is multiplied by R gain, and in the same manner, the Gr signal by Gr gain, the B signal by B gain, and the Gb signal by Gb gain. The respective gains used for the multiplication are selected by the selector 13 in accordance with a color of the inputted image signal and read from the gain data memorizing unit 12.

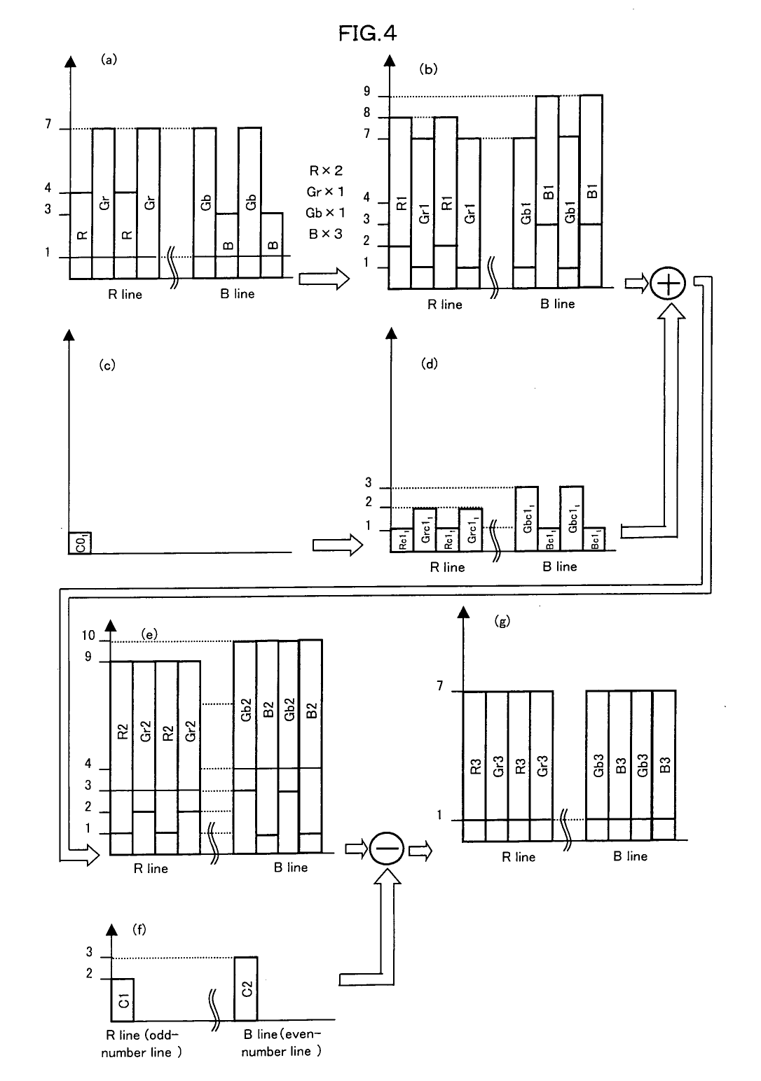

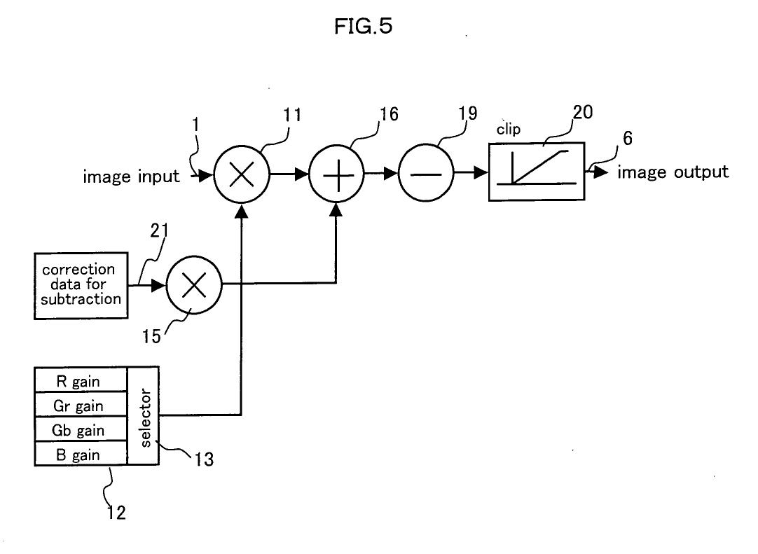

The foregoing gain multiplying process is described referring to FIG. 4. Input signal levels of a photographic object in white color are R signal: Gr signal: Gb signal: B signal=3:6:6:2, based on a color temperature of a light source. However, a noise level of the dark current is superposed on the image signal at the rate of “1”, and the input signal levels of the image signal including the noise of the dark current result in R signal:Gr signal:Gb signal:B signal=4:7:7:3 as shown in FIG. 4A. R gain:2, Gr gain=Gb gain=1, B gain=3 is set and the image signal is thereby multiplied. Provided that the gain-multiplied R signal, Gr signal, Gb signal and B signal are respectively an R1 signal, a Gr1 signal, a Gb1 signal and a B1 signal, the followings are obtained.
R1=4×2=8
(image signal level=6/noise level=2)
   Gr1=Gb1=7×1=7
(image signal level=6/noise level=1)
   B1=3×3=9
(image signal level=6/noise level=3)

Therefore, an output of the multiplier 11 is as shown in FIG. 4B.

To further describe the operation referring to FIG. 3, correction data for addition C0₁ is read from the addition correction data memorizing section 14 and inputted to the multiplier 15. The addition correction data C0₁ is set in compliance with the anticipated noise level of the dark current and previously memorized in the addition correction data memorizing section 14. The multiplier 15 multiplies the inputted addition correction data C0₁ by a gain. The gain used for the multiplication is selected by the selector 13 in compliance with the color of the inputted image signal and read from the gain data memorizing section 12. However, it is not the gain corresponding to the inputted image signal but the gain corresponding to another color (image signal) on the same line, which is used for the multiplication in the foregoing operation. More specifically, the addition correction data C0₁ is multiplied by, respectively, the Gr gain in the case of the R signal, the R gain in the case of the Gr signal, the B gain in the case of the Gb signal, and the Gb gain in the case of the B signal.

The foregoing multiplying process is described referring to FIGS. 4C and 4D. The addition correction data C0₁ is “1” in accordance with the noise level of the dark current (see FIG. 4C). Provided that the gain-multiplied addition correction data are respectively Rc1₁, Grc1₁, Gbc1₁, and Bc1₁, the followings are obtained.
Rc1₁=C0₁×Gr gain=1×1=1
Grc1₁=C0₁×R gain=1×2=2
Gbc1₁=C0₁×B gain=1×3=3
Bc1₁=C0₁×Gb gain=1×1=1

Therefore, an output of the multiplier 15 is as shown in FIG. 4D.

To further describe the operation referring to FIG. 3, the adder 16 adds the addition correction data multiplied by the multiplier 15, which are Rc1₁, Grc1₁, Gbc1₁, and Bc1₁, to the image signal multiplied by the multiplier 11. Thereby, an imbalance of the noise level of the dark current included in the image signal multiplied by the multiplier 11 is negated by the addition correction data multiplied by the multiplier 15, which are Rc1₁, Grc1₁, Gbc1₁, and Bc1₁, so that any signal level other than that of the image signal can be equal in each line.

The foregoing effect is described referring to FIG. 4E. Provided that the post-addition R signal, Gr signal Gb signal and B signal are respectively an R2 signal, a Gr2 signal, a Gb2 signal and a B2 signal, the followings are obtained.
R2=R1+Rc1₁=8+1=9
(image signal level=6/[noise+correction] level=3)
   Gr2=Gr1+Grc1₁=7+2=9
(image signal level=6/[noise+correction] level=3)
   Gb2=Gb1+Gbc1₁=7+3=10
(image signal level=6/[noise+correction] level=4)
   B2=B1+Bc1₁=9+1=10
(image signal level=6/[noise+correction] level=4)

As shown above, in the R line, the image signal levels of the R signal and the Gr signal are both “6”, and the [noise+correction] levels are both “3”. In the B line, the image signal levels of the Gb signal and the B signal are both “6”, and the [noise+correction] levels are both “4”. Accordingly, an output of the adder 16 is as shown in FIG. 4E.

To further describe the operation referring to FIG. 3, as a result of implementing the process described so far, in which the image signal is multiplied by the gain after any signal level other than that of the image signal, that is the [noise+correction] level of the dark current, is made to be constant in each line, the white balance can be adjusted. However, the [noise+correction] levels result in higher values in consequence of adding the addition correction data Rc1₁, Grc1₁, Gbc1₁, and Bc1₁. Further, the [noise+correction] level in the R line and the [noise+correction] level in the B line are different to each other.

In order to deal with that, the following process is executed to equalize any signal level other than that of the image signal between the R line and the B line so that any signal level ([noise+correction] level) other than that of the image signal can be reduced. Correction data for subtraction C1 and C2 selected by the selector 17 in each line are used for subtraction by the subtracter 19. The subtraction correction data C1 and C2 are preset in accordance with the gain of each color and the anticipated noise level of the dark current and memorized in the subtraction correction data memorizing section 18.

The foregoing process is described referring to FIGS. 4F and 4G. In examples shown in FIG. 4, the subtraction correction data C1 of the R line is at the level 2, while the subtraction correction data C2 of the B line is at the level 3, as shown in FIG. 4F. Then, provided that the R signal, Gr signal, Gb signal and B signal which was subjected to the subtraction by the subtracter 19 are respectively an R3 signal, a Gr3 signal, a Gb3 signal and a B3 signal, the followings are obtained.
R3=R2−C1=9−2=7
(image signal level=6/[noise+correction] level=1)
   Gr3=Gr2−C1=9−2=7
(image signal level=6/[noise+correction] level=1)
   Gb3=Gb2−C2=10−3=7
(image signal level=6/[noise+correction] level=1)
   B3=B2−C2=10−3=7
(image signal level=6/[noise+correction] level=1)

Therefore, an output of the subtracter 19 is as shown in FIG. 4G.

To further describe the operation referring to FIG. 3. in the process described so far, the white balance of the image signal including the dark current can be accurately corrected, however, the post-operation image signal may overflow or underflow depending on the operation value and/or inputted signal level. Therefore, upper and lower limits of the post-correction image signal level are subjected to restriction by the clipping circuit 20. The image signal clipping-processed by the clipping circuit 20 is outputted from the image output unit 6.

As a result of the foregoing process, the white balance adjustment can be appropriately implemented even to the image signal including the noise level of the dark current. The white balance can be adjusted without losing subtle shades and shadows of the photographic object because the noise level is adjusted to equalize the signal levels after the gain multiplication for the white balance adjustment instead of the noise level being subjected to the subtraction prior to the gain multiplication for the white balance adjustment.

The present invention was described referring to the single-plate solid image sensor element, however, can flexibly respond to an image processing device employing a plurality of solid image sensor elements. The present invention is not limited to the Bayer array and applicable to the white balance adjusting process color filters of any type of array.

### EMBODIMENT 2

An embodiment of the present invention is described referring to the drawings. FIG. 5 is a detailed illustration of an image processing device according to the embodiment 2. The correction data 3 in FIG. 1 corresponds to correction data for subtraction in FIG. 5. The subtraction correction data is preset and memorized in a correction data memorizing section for subtraction 21. A multiplier 11 constitutes an image signal operation unit 2. A multiplier 15 constitutes a correction data operation unit 4. A gain data memorizing section 12 and a selector 13 constitute a gain selecting unit 7. A subtracter 19 and a clipping circuit 20 constitute a correcting unit 5.

Below is described an action of the image processing device according to the present invention. First, an image signal of a Bayer-arrayed single-plate solid image sensor element is inputted from an image input unit 1. In R line of the image signal, an R signal, a Gr signal, the R signal, the Gr signal, . . . are alternately inputted, while a Gb signal, a B signal, the Gb signal, the B signal, . . . are alternately inputted in B line thereof. A noise of a dark current is superposed on the image signal.

The multiplier 11 multiplies the inputted image signal by a gain. More specifically, the R signal is multiplied by R gain, and in the same manner, the Gr signal by Gr gain, the B signal by B gain, and the Gb signal by Gb gain. The gain used for the multiplication is selected by the selector 13 in accordance with a color of the inputted image signal and read from a gain data memorizing section 12.

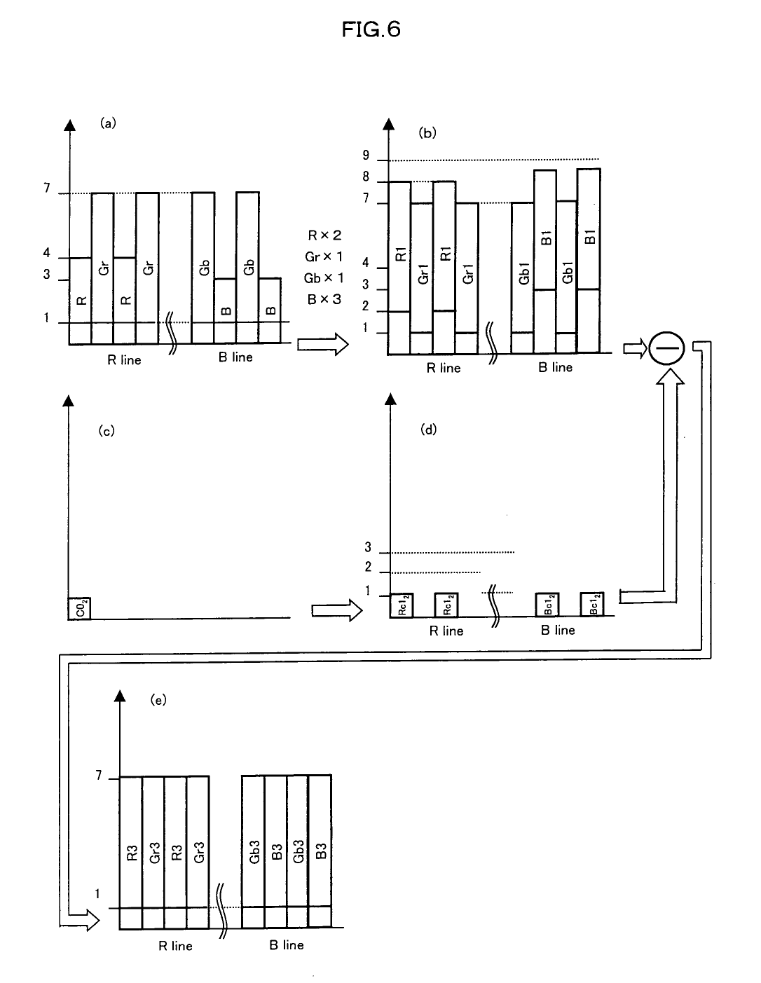

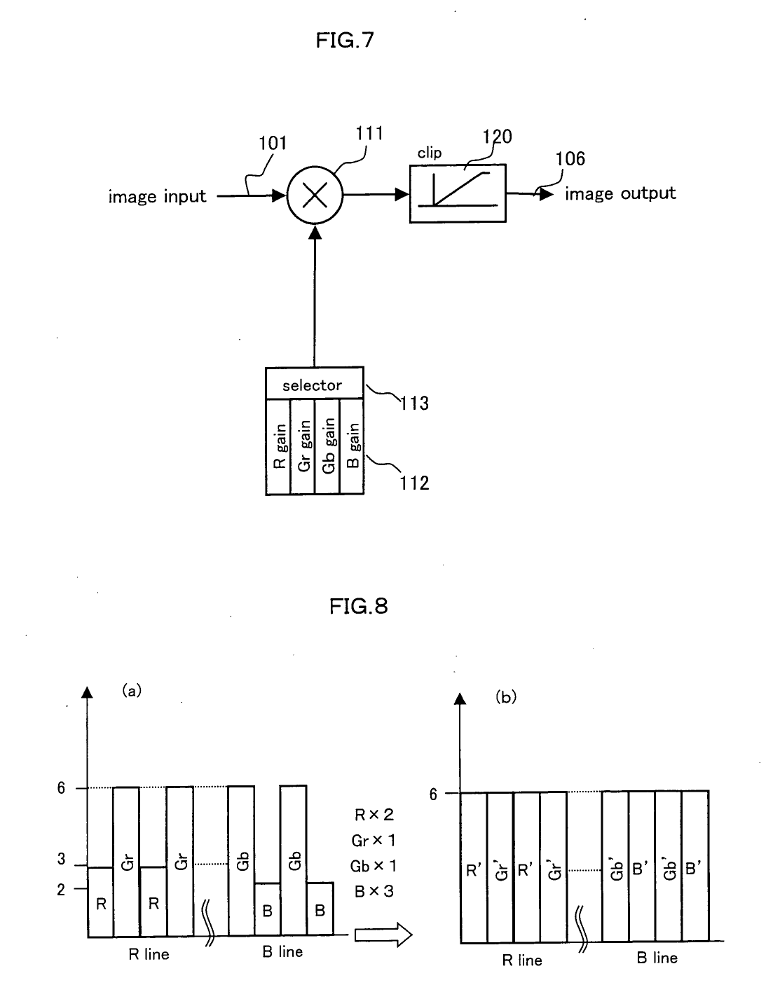

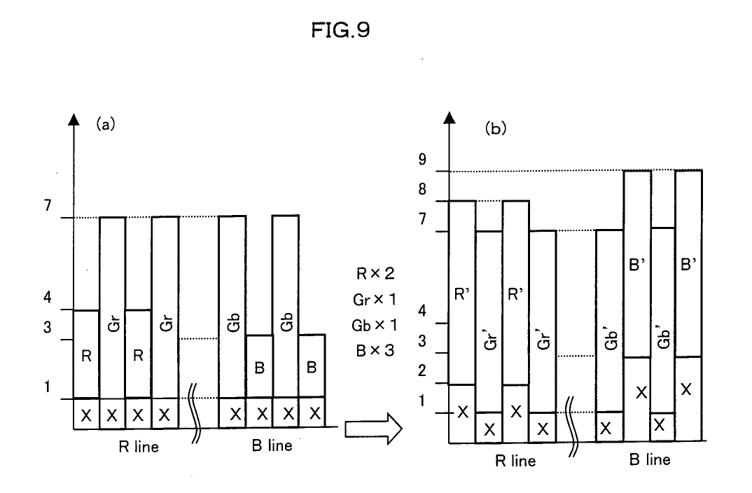

The foregoing gain multiplying process is described referring to FIG. 6. It is assumed that input signal levels of the photographic object in the white color are, R signal: Gr signal:Gb signal:B signal=3:6:6:2, based on a color temperature of the image signal. However, a noise level of the dark current is superposed on the image signal at the rate of “1”, and the input signal levels of the image signal including the noise of the dark current are R signal: Gr signal: Gb signal: B signal=4:7:7:3, as shown in FIG. 6A. Now, R gain:2, Gr gain=Gb gain=1, B gain=3 is set, by which the image signal is multiplied. Provided that the gain-multiplied R signal, Gr signal, Gb signal and B signal are respectively an R1 signal, a Gr1 signal, a Gb1 signal and a B1 signal, the followings are obtained.
R1=4×2=8
(image signal level=6/noise level=2)
   Gr1=Gb′1=7×1=7
(image signal level=6/noise level=1)
   B1=3×3=9
(image signal level=6/noise level=3)

Therefore, an output of the multiplier 11 is as shown in FIG. 6B.

To further describe the operation referring to FIG. 5, correction data for subtraction C0₂ is read from the subtraction correction data memorizing section 21 and inputted to the multiplier 15. The subtraction correction data C0₂ is set in compliance with the anticipated noise level of the dark current and previously memorized in the subtraction correction data memorizing section 21. The multiplier 15 multiplies the inputted subtraction correction data C0₂ by a gain. The gain used for the multiplication is selected by the selector 13 in compliance with the color of the inputted image signal and read from the gain data memorizing section 12. It is noted that the gain corresponding to the inputted image signal is not used for the foregoing multiplication, but “1” is subtracted from the gain which is preset as the gain corresponding to the inputted image signal, and the post-subtraction gain is used for the multiplying operation. More specifically, the subtraction correction data C0₂ is multiplied by, respectively, [R gain−1] in the case of the R signal, [Gr gain−1] in the case of the Gr signal, [Gb gain−1] in the case of the Gb signal, and [B gain−1] in the case of the B signal.

The foregoing multiplying process is described referring to FIGS. 6C and 6D. The subtraction correction data CO₂ is “1” in accordance with the noise level of the dark current (see FIG. 6C). Provided that the subtraction correction data after the multiplying process are respectively Rc1₂, Grc1₂, Gbc1₂, and Bc1₂, the followings are obtained.
Rc1₂=C0₂×(R gain−1)=1×1=1
Grc1₂=C0₂×(Gr gain−1)=1×0=0
Gbc1₂=C0₂×(Gb gain−1)=1×0=0
Bc1₂=C0₂×(B gain−1)=1×2=2

Therefore, an output of the multiplier 15 is as shown in FIG. 6D.

To further describe the operation referring to FIG. 5, multiplied by the multiplier 15, which are Rc1₂, Grc1₂, Gbc1₂, and Bc1₂, from the image signal multiplied by the multiplier 11. Thereby, an imbalance of the noise level of the dark current included in the image signal multiplied by the multiplier 11 is negated by the subtraction correction data multiplied by the multiplier 15, which are Rc1₂, Grc1₂, Gbc1₂, and Bc1₂, so that any signal level other than that of the image signal can be equal in each line.

The foregoing effect is described referring to FIG. 6E. Provided that the post-subtraction R signal, Gr signal Gb signal and B signal are respectively an R3 signal, a Gr3 signal, a Gb3 signal and a B3 signal, the followings are obtained.
R3=R1−Rc1₂=8−1=7
(image signal level=6/[noise+correction] level=1)
   Gr3=Gr1−Grc1₂=7−0=7
(image signal level=6/[noise+correction] level=1)
   Gb3=Gb1−Gbc1₂=7−0=7
(image signal level=6/[noise+correction] level=1)
   B3=B1−Bc1₂=9−2=7
(image signal level=6/[noise+correction] level=1)

Therefore, an output of the multiplier 19 is as shown in FIG. 6E.

To further describe the operation referring to FIG. 5, when the process described so far is implemented, the white balance of the image signal including the dark current can be adjusted. However, the image signal levels from which the subtraction correction data, Rc1₂, Grc1₂, Gbc1₂, and Bc1₂, are respectively subtracted may overflow or underflow depending on the operation value or inputted image signal level. Therefore, upper and lower limits of the corrected image signal level are subjected to restriction by the clipping circuit 20. The image signal clipped in the clipping-processed circuit 20 is outputted from the image output unit 6.

As a result of the foregoing process, the white balance adjustment can be appropriately implemented even to the image signal including the noise level of the dark current. Further, the white balance can be adjusted without losing subtle shades and shadows of the photographic object because the noise level is adjusted to equalize the signal levels after the gain multiplication for the white balance adjustment instead of the noise level being subjected to the subtraction prior to the gain multiplication for the white balance adjustment.

The present invention was described referring to the single-plate solid image sensor element, however, can flexibly respond to an image processing device employing a plurality of solid image sensor elements. The present invention is not limited to the Bayer array and applicable to the white balance adjusting process color filters of any type of array.

An optimum white-balance adjustment can be realized by the image processing device according to the present invention. Therefore, the present invention can be applied to a camera using a solid image sensor element (digital still camera, camera-incorporated mobile phone, and the like).

While there has been described what is at present considered to be preferred embodiments of this invention, it will be understood that various modifications may be made therein, and it is intended to cover in the appended claims all such modifications as fall within the true spirit and scope of this invention.

1. An image processing method for adjusting a white balance of an image signal outputted from a solid image sensor element comprising:
an adjusting step in which the white balance of the image signal is adjusted by controlling a gain of the image signal for each color constituting the image signal; and
a correcting step in which correction data for eliminating an influence of a dark current included in the white-balance adjusted image signal from the white-balance adjusted image signal is created, and the white-balance adjusted image signal is further corrected based on the correction data.

2. An image processing method as claimed in claim 1, wherein the correcting step includes:
a step in which correction data for equalizing any gain of the image signal is created in each line of the solid image sensor element as the correction data;
a step in which the correction data is added to the white-balance adjusted image signal so as to equalize any gain of the image signal in the each line of the solid image sensor element; and
a step in which correction data for subtraction for equalizing any gain of the image signal between the respective lines of the solid image sensor element is subtracted from the image signal whose gains in the each line of the solid image sensor element are equalized so as to equalize any gain of the image signal between the respective lines of the solid image sensor element.

3. An image processing method as claimed in claim 2, wherein the correction data for eliminating the influence of the dark current included in the image signal from the white-balance adjusted image signal is subtracted from the white-balance adjusted image signal so as to equalize any gain of the image signal in the each line of the solid image sensor element and equalize any gain between the respective lines of the solid image sensor element in the correction step.

4. An image processing device for adjusting a white balance of an image signal outputted from a solid image sensor element comprising:
an image signal operation unit for adjusting the white balance of the image signal by controlling a gain of the image signal for each color constituting the image signal;
a correction data operation unit for creating correction data for correcting an output of the image signal operation unit; and
a correcting unit for correcting the output of the image signal operation unit based on the correction data created by the correction data operation unit.

5. An image processing device as claimed in claim 4, wherein
the correction data operation unit creates correction data for eliminating an influence of a dark current included in the image signal from the output of the image signal operation unit.

6. An image processing device as claimed in claim 5, wherein
the correction data operation unit creates correction data for equalizing any gain of the image signal in each line of the solid image sensor element, and
the correcting unit comprises:
an adder for adding the correction data created by the correction data operation unit to the output of the image signal operation unit so as to equalize any gain of the image signal in the each line of the solid image sensor element;
a correction data memorizing section for subtraction for memorizing correction data for subtraction for equalizing any gain of the image signal between the respective lines of the solid image sensor element; and
a subtracter for subtracting the correction data for subtraction memorized in the correction data memorizing section for subtraction from an output of the adder so as to equalize any gain of the image signal between the respective lines of the solid image sensor element.

7. An image processing device as claimed in claim 5, wherein
the correcting unit subtracts the correction data obtained by the correction data operation unit from the output of the image signal operation unit so as to equalize any gain of the image signal in the each line of the solid image sensor element and equalize any gain between the respective lines of the solid image sensor element.
